(19) United States
(12) Patent Application Publication
(10) Pub. No.: US 2025/0002732 A1
(43) Pub. Date: Jan. 2, 2025

(54) TRANSLUCENT COATING SYSTEMS, METHOD FOR PRODUCING THE COATING SYSTEMS, AND USE OF THE COATING SYSTEMS

(71) Applicant: MANKIEWICZ GEBR. & CO. (GMBH & CO. KG), HAMBURG (DE)

(72) Inventors: UMBERTO DE ROSSI, NORDERSTEDT (DE); CHRISTIAN PREISSING, HAMBURG (DE); FABIAN MOHWINKEL, HAMBURG (DE); ANASTASIA URBANIAK, TOSTEDT (DE)

(73) Assignee: MANKIEWICZ GEBR. & CO. (GMBH & CO. KG), HAMBURG (DE)

(21) Appl. No.: 18/292,343

(22) PCT Filed: Aug. 12, 2022
(86) PCT No.: PCT/DE2022/100597

§ 371 Date: Jan. 26, 2024

(30) Foreign Application Priority Data
Aug. 13, 2021 (DE) 10 2021 004 169.0

(51) Int. Cl. C09D 5/24; C09D 5/00; C09D 7/42; C09D 7/61; C09D 175/04; C09D 175/06

(52) U.S. Cl. CPC C09D 5/24; C09D 5/002; C09D 7/42; C09D 7/61; C09D 175/04; C09D 175/06

(57) ABSTRACT

A translucent coating system includes a primer layer which is laser-engravable, a base coat layer which is translucent, and a clear coat layer.

### CROSS REFERENCE TO PRIOR APPLICATIONS

This application is a U.S. National Phase application under 35 U.S.C. § 371 of International Application No. PCT/DE2022/100597, filed on Aug. 12, 2022 and which claims benefit to German Patent Application No. 10 2021 004 169.0, filed on Aug. 13, 2021. The International Application was published in German on Feb. 16, 2023 as WO 2023/016608 A1 under PCT Article 21 (2).

### FIELD

The present invention relates to a translucent, multi-layer structure for the coating of surfaces. The coating system according to the present invention is in particular suitable for indicating and operating buttons on the surface of a substrate which is backlit by a light source, the present invention also relates to coating materials and compositions thereof for the production of backlightable and transilluminable coating systems. The coating systems obtained are in particular suitable for surfaces having integrated lighting, such surfaces being used, for example, in displays or in dashboards.

### BACKGROUND

Translucent covering parts for motor vehicles are described in EP 3632749 A1. They consist of a translucent or transparent base body to which a lacquer foil is applied that contains perforations in selected areas. Light from a light source mounted behind or below the substrate can shine through these perforations. The lacquer foil is sealed with a clear coat layer so that the perforations are not visible. During backlighting, a gleam of light in the size and shape of the perforated area is produced. The color of the light is thereby determined by the light source used. As is commonly known, the application of foils to uneven surfaces, for example, bent or structured surfaces, is problematic. Heat and moisture also have a detrimental effect on adhesion so that the foils may detach from the substrate. Commonly employed foils and plastics are also sensitive to scratches.

### SUMMARY

An aspect of the present invention is to provide improved backlightable and translucent coating systems which overcome the above common disadvantages.

In an embodiment, the present invention provides a translucent coating system which includes a primer layer which is laser-engravable, a base coat layer which is translucent, and a clear coat layer. The present invention further relates to methods for producing these translucent coating systems as well as their use for backlightable components.

### DETAILED DESCRIPTION

The term “coating system” is hereinafter defined as a coating or coating structure consisting of several layers. In this connection, the individual layers are applied through application and curing of the coating materials. The term “translucence” is hereinafter defined as the partial light transmission of a body.

The primer layer according to the present invention has one or more coatings which are obtained by application and curing of suitable coating materials on a substrate surface. Primers are referred to as both coating materials and the coatings obtained therefrom which are directly applied to the substrate surface and which assume certain functions, such as improving adhesion between substrate and coating.

The primer compositions employed according to the present invention are opaque and laser-engravable. Laser engraving is an engraving technique where material is heated through a laser beam to such an extent that it vaporizes or burns. In order to maintain sharp contours and clear, transparent surfaces in the engraving, the material must vaporize or burn without leaving any residue.

Primer coatings based on polyurethane, which are obtained from two-component compositions with a polyol component as binder and an isocyanate component as harder, are suitable therefor. The primer compositions according to the present invention contain 10 to 80% by weight of at least one polyol, 5 to 30% by weight of at least one pigment, as well as 3 to 25% by weight of at least one filler in the binder component.

Suitable polyols are those commonly used in the production of polyurethanes and which are familiar to the person skilled in the art, such as polyether polyols, polycaprolactone polyols, polyester polyols, polycarbonate polyols, polyacrylate polyols, polyols based on dimeric fatty acids, and mixtures thereof. Polycarbonate polyols, polyacrylate polyols, and mixtures thereof can, for example, be used.

Suitable pigments are the usual inorganic and organic pigments familiar to the person skilled in the art, such as carbon black, titanium dioxide, iron oxides, perylene pigments, and mixtures thereof. The use of carbon black, perylene pigments, and mixtures thereof can, for example, be used.

Suitable fillers are, for example, oxidic, carbonate, sulphate, silicate fillers with alkali or alkaline earth cations as well as cations of the third and fourth main group of the periodic system of the elements as counterions. Barium sulphate, talc, calcium carbonate, silicon dioxide, and mixtures thereof can, for example, be used.

The primer-binder components according to the present invention may also contain at least one solvent, for example, in proportions of 0.01 to 82% by weight. Suitable solvents are the usual solvents familiar to the person skilled in the art, such as aliphatic hydrocarbons, aromatic hydrocarbons and mixture thereof. Acetic acid esters, aromatic hydrocarbons, such as xylenes and mixtures thereof, can, for example, be used, as can n-butyl acetate, methoxypropyl acetate, i-butyl acetate and mixtures thereof.

In addition thereto, the primer-binder components may have at least one additive, for example, in proportions of 0.1 to 20% by weight. Suitable additives are those customary and familiar to the person skilled in the art, in particular wetting agents, defoamers, levelling agents and adhesion promoters.

The primer compositions according to the present invention contain at least one isocyanate in the hardener component. Suitable isocyanates are those commonly used for the production of polyurethane and which are familiar to the person skilled in the art, for example, oligomers or prepolymers based on toluylene diisocyanate (TDI), hexamethylene diisocyanate (HDI), isophorone diisocyanate (IPDI), 4,4′-diisocyanato dicyclohexylmethane (HMDI), 1,6-diisocyanato trimethylhexane (TMDI), and mixtures thereof. Aliphatic isocyanates, in particular oligomers based on hexamethylene diisocyanate (HDI) can, for example, be used.

In another embodiment of the present invention, the hardener components can, for example, further contain at least one solvent, for example, in proportions of 0.01 to 70% by weight. Suitable solvents are those commonly used and which are familiar to the person skilled in the art, such as aliphatic hydrocarbons, aromatic hydrocarbons, and mixtures thereof. Acetic acid esters, aromatic hydrocarbons and mixtures thereof can, for example, be used. Butyl acetates, xylenes, and mixtures thereof can, for example, be used.

The binder component and the hardener component of the primer composition are used in a molar ratio of the OH groups of the binder to the NCO groups of the hardener in the range from 1:0.5 to 1:2, for example, from 1:0.8 to 1:1.3, for example, from 1:0.9 to 1:1.1.

The primer compositions are highly opaque. They are therefore able to form layers with very low dry film thickness without impairing desired properties. The dry film thickness according to the present invention is between 2 and 40 μm, for example, between 2 and 20 μm, for example, between 2 and 10 μm.

In a further embodiment of the present invention, the primer compositions may, for example, further contain electrically conductive particles. The primer compositions according to the present invention contain electrically conductive particles in a quantity of 1 to 40% by weight, for example, 10 to 30% by weight, for example, 15 to 25% by weight. Suitable substances are conductive carbon black, silver nanowires, electrically conductive polymers, indium tin oxide, silver, indium tin oxide-doped mica, conductive titanium dioxide, graphene, antimony tin oxide, antimony tin oxide-doped mica, aluminum-doped tin oxide, and mixtures thereof. Conductive carbon black can, for example, be used. The conductive particles can, for example, be contained in the primer-binder component.

An electrically conductive primer layer is obtained once the conductive particles are added. Electrical signals for operating or switching functions can thus be generated by touch of the surface of the coating system with a material that is also conductive, such as a hand or a finger.

The base coat layer according to the present invention has one or more coatings which are obtained by the application and curing of suitable coating materials. The term “base coat” is hereinafter defined as a coloring lacquer or coating within a coating system.

Suitable base coat coatings are those based on polyurethane and which are obtained from two-component compositions with a polyol component as binder and an isocyanate component as hardener. The base coat compositions according to the present invention contain, in the binder component, 1 to 90% by weight of at least one polyol, 0.1 to 5% by weight of at least one catalyst, 0.5 to 60% by weight of a mixture containing at least one pigment and at least one filler, as well as 0.5 to 50% by weight of at least one additive. Suitable polyols are those commonly used for the production of polyurethanes and which are familiar to the person skilled in the art, such as polyether polyols, polycaprolactone polyols, polyester polyols, polycarbonate polyols, polyacrylate polyols, polyols based on dimeric fatty acids, and mixtures thereof. Polycaprolactone polyols, polycarbonate polyols, polyester polyols, and mixtures thereof can, for example, be used according to the present invention.

Suitable catalysts are those commonly used for the production of polyurethanes and which are familiar to the person skilled in the art, such as organometallic complexes with tin, zirconium, titanium or bismuth as the central atom, tertiary amines, and mixtures thereof. Dibutyltin dilaurate can, for example, be used.

Suitable pigments are the usual inorganic and organic pigments familiar to the person skilled in the art. Suitable inorganic pigments are, for example, titanium dioxide, iron oxide, chromium oxides, chromium titanates, bismuth vanadate, cobalt blue, carbon blacks, and mixtures thereof. Suitable organic pigments are, for example, Pigment Yellow 151, Pigment Yellow 213, Pigment Yellow 83, Pigment Orange 67, Pigment Orange 62, Pigment Orange 36, Pigment Red 170, Pigment Violet 19, Pigment Violet 23, Pigment Blue 15:3, Pigment Blue 15:6, Pigment Green 7, and mixtures thereof.

Suitable fillers are, for example, oxidic, carbonate, sulphate, silicate fillers with alkali or alkaline earth cations as well as cations of the third and fourth main group of the periodic system of the elements as counterions. Barium sulphate, talc, calcium carbonate, silicon dioxide, and mixtures thereof can, for example, be used.

Suitable additives are, for example, light stabilizers, dispersants, rheological additives, defoamers, levelling agents, wetting agents, and mixtures thereof. Light stabilizers, dispersants, rheological additives, defoamers, and mixtures can, for example, be used.

The base coat-binder components according to the present invention may further contain at least one matting agent, for example, in proportions of 0.1 to 20% by weight. Suitable matting agents are, for example, silicates (salts and esters of the orthosilicic acid and their condensates), amorphous silicas, precipitated silicas, micronized waxes such as polyethylene waxes, polypropylene waxes, polyamide waxes, PTFE waxes, micronized polymers such as urea aldehyde resins, beeswaxes, carnauba waxes, and mixtures thereof. Silicates, silicas, polyethylene waxes, polypropylene waxes, polyamide waxes, and mixtures thereof can, for example, be used.

The base coat-binder components may furthermore contain at least one solvent, for example, in proportions of 1 to 83% by weight. Suitable solvents are aromatic hydrocarbons, aliphatic hydrocarbons, carboxylic acid esters, ethers, and mixtures thereof. Aromatic hydrocarbons, acetic acid esters, and mixtures thereof can, for example, be used. Xylene, butyl acetates, and mixtures thereof can, for example, be used.

The base coat compositions according to the present invention contain at least one isocyanate in the hardener component. Suitable isocyanates are those commonly used for the production of polyurethane and which are familiar to the person skilled in the art, such as oligomers and prepolymers based on hexamethylene diisocyanate (HDI), isophorone diisocyanate (IPDI), 4,4′-diisocyanato dicyclohexylmethane (HMDI), 1,6-diisocyanato trimethylhexane (TMDI), and mixtures thereof. Oligomers based on hexamethylene diisocyanate (HDI) or isophorone diisocyanate (IPDI), and mixtures thereof can, for example, be used.

In a further embodiment of the present invention, the hardener components may, for example, further contain at least one solvent, for example, in proportions of 0.01 to 50% by weight. Suitable solvents are those customary and familiar to the person skilled in the art, such as aliphatic hydrocarbons, aromatic hydrocarbons, and mixtures thereof.

The binder component and the hardener component of the base coat composition are used in a molar ratio of the OH groups of the binder to the NCO groups of the hardener in the range from 1:0.5 to 1:2, for example, from 1:0.8 to 1:1.3, for example, from 1:0.9 to 1:1.1.

The clear coat layer according to the present invention has one or more coatings which are obtained by the application and curing of suitable coating materials. The term “clear coat” is hereinafter defined as a transparent lacquer or coating with protective, decorative or specific technical properties.

Suitable clear coat coatings are those based on polyurethane, which are obtained from two-component compositions with a polyol component as binder and an isocyanate component as hardener. The clear coat compositions according to the present invention contain, in the binder component, 20 to 70% by weight of at least one polyol and 5 to 30% by weight of at least one additive.

Suitable polyols are those commonly used for the production of polyurethanes and which are familiar to the person skilled in the art, such as polyether polyols, polycaprolactone polyols, polyester polyols, polycarbonate polyols, polyacrylate polyols, polyols based on dimeric fatty acids, and mixtures thereof. Polyester polyols can, for example, be used.

Suitable additives are those customary and familiar to the person skilled in the art, such as light stabilizers, dispersants, rheological additives, defoamers, levelling agents, wetting agents and mixtures thereof.

In a further embodiment of the present invention, the clear coat-binder components may additionally have at least one matting agent, for example, in proportions of 8 to 14% by weight.

Suitable matting agents are, for example, silicates (salts and esters of the orthosilicic acid and their condensates), amorphous silicas, precipitated silicas, micronized waxes such as polyethylene waxes, polypropylene waxes, polyamide waxes, PTFE waxes, micronized polymers such as urea aldehyde resins, beeswaxes, carnauba waxes, and mixtures thereof. Silicates, silicas, polyethylene waxes, polypropylene waxes, polyamide waxes, and mixtures thereof can, for example, be used.

The clear coat-binder components may furthermore contain at least one solvent, for example, in proportions of 0.3 to 75% by weight. Suitable solvents are aromatic hydrocarbons, aliphatic hydrocarbons, carboxylic acid esters, ethers, and mixtures thereof. Aromatic hydrocarbons, acetic acid esters, and mixtures thereof can, for example, be used. Xylenes, butyl acetates, and mixtures thereof can, for example, be used.

The clear coat compositions according to the present invention contain at least one isocyanate in the hardener component. Suitable isocyanates are those commonly used for the production of polyurethane and which are familiar to the person skilled in the art, such as oligomers and prepolymers based on hexamethylene diisocyanate (HDI), isophorone diisocyanate (IPDI), 4,4′-diisocyanato dicyclohexylmethane (HMDI), 1,6-diisocyanato trimethylhexane (TMDI), and mixtures thereof. Oligomers based on hexamethylene diisocyanate (HDI) or isophorone diisocyanate (IPDI), and mixtures thereof can, for example, be used.

In a further embodiment of the present invention, the hardener components may, for example, further contain at least one solvent, for example, in proportions of 0.01 to 30% by weight. Suitable solvents are aromatic hydrocarbons, aliphatic hydrocarbons, carboxylic acid esters, ethers, and mixtures thereof. Aromatic hydrocarbons, acetic acid esters and mixtures thereof can, for example, be used. Xylenes, butyl acetates and mixtures thereof can, for example, be used.

The binder component and the hardener component of the clear coat composition are used in a molar ratio of the OH groups of the binder to the NCO groups of the hardener in the range from 1:0.5 to 1:2, for example, from 1:0.8 to 1:1.3, for example, from 1:0.9 to 1:1.1.

The coating system according to the present invention is produced by a method comprising at least the following steps:
(a) application of at least one primer coating to a translucent or transparent substrate in order to produce the primer layer,
(b) partial removal of the primer layer from the substrate surface by laser engraving,
(c) application of at least one translucent base coat coating to the engraved primer layer in order to produce the base coat layer, and
(d) application of at least one clear coat coating to the base coat layer in order to produce the clear coat layer.

The coating systems according to the present invention with their combination of primer layer, base coat layer and clear coat layer are particularly suited for the creation of smooth surfaces on backlightable components. When illuminated by a light source which, as seen by an observer, is positioned behind the component, only those sections are illuminated where the opaque primer layer has been removed by laser engraving. Without illumination, the components coated according to the present invention show a smooth, painted surface. Unlike the foils used to date, the coatings according to the present invention may also be used on components with strongly curved surfaces and on small components, such as control knobs or controllers. When an electrically conductive primer layer is employed, these surfaces may additionally fulfil operating or switching functions, in that the primer layer has been removed by the laser engraving in the illuminated sections.

In a further embodiment of the method of the present invention, an additional step (e) is carried out after the engraving of the primer layer in step (b) and prior to the application of the base coat layer in step (c), a further clear coat layer being produced by application of at least one clear coat coating to the engraved primer layer. Clear coat compositions containing matting agents can, for example be used in step (e).

Due to this four-layer construction of the coating system according to the present invention, very homogeneous and smooth surfaces are obtained, which are particularly suitable for coatings with high-gloss and metallic effects. High-gloss surfaces and/or surfaces with metallic effect can be created on a component, with the surfaces exhibiting multi-colored sections only when they are backlit. These surfaces may also additionally have operating or switching functions.

The coating systems according to the present invention are highly resistant to moisture, chemicals, and mechanical stress, so that they are particularly suitable for coating components of vehicles, aircraft and ships, for example, for coating exterior and interior coverings with integrated lighting.

The coating systems according to the present invention are suitable to be used for backlightable components which are illuminated only in selected areas of their surface. In a further embodiment of the present invention, the illuminated areas can, for example, have operating or switching functions.

The coating systems according to the present invention are particularly suitable to be used on automotive components in the exterior and interior areas, as they meet the requirements in terms of adhesion, ageing, hydrolysis resistance, cream resistance, chemical resistance, abrasion behavior, scratch resistance, and abrasion resistance.

### Examples

### Compositions of the Coating Materials

Example 1: Laser-Engravable Primer

| | Proportion |
|---|---|
| Constituent | [% by weight] |
| Binder Component | |
| Acrylate polyol (OH number 6 to 12 mg KOH/g) | 18 |
| Carbonate diol (OH number 118 to 132 mg KOH/g) | 3 |
| Precipitated barium sulphate | 17 |
| Carbon black | 16 |
| Surface additive | 0.5 |
| Wetting agent | 14.5 |
| Butyl acetate | 31 |
| Hardener | |
| Aliphatic polyisocyanate (90% in butyl acetate | 84 |
| and solvent naphtha with NCO content of 19.6%) | |
| Butyl acetate | 10 |
| Xylene | 6 |

Example 2: Conductive, Laser-Engravable Primer

| | Proportion |
|---|---|
| Constituent | [% by weight] |
| Binder Component | |
| Acrylate polyol (OH number 6 to 12 mg KOH/g) | 18 |
| Carbonate diol (OH number 118 to 132 mg KOH/g) | 3 |
| Precipitated barium sulphate | 17 |
| Conductive carbon black | 16 |
| Surface additive | 0.5 |
| Wetting agent(s) | 14.5 |
| Butyl acetate | 31 |
| Hardener Component | |
| Aliphatic polyisocyanate (90% in butyl acetate | 84 |
| and solvent naphtha with NCO content of 19.6%) | |
| Butyl acetate | 10 |
| Xylene | 6 |

Example 3: Base Coat

| | Proportion |
|---|---|
| Constituent | [% by weight] |
| Binder Component | |
| Polyester resin containing hydroxyl groups | 19 |
| (OH number 185 to 205 mg KOH/g) | |
| Aliphatic polycarbonate polyester | 8.5 |
| (OH number 56 mg KOH/g) | |
| Precipitated barium sulphate | 28 |
| Talc | 4 |
| Pigment | 0.8 |
| Matting agent(s) | 5.8 |
| Rheological additives | 1.5 |
| Surface additive | 3 |
| Wetting agent(s) | 0.2 |
| Catalyst | 0.1 |
| Butyl acetate | 17 |
| Xylene | 10.7 |
| Methoxypropyl acetate | 0.1 |
| Butyl glycol | 0.4 |
| Solvent naphtha | 0.4 |
| Propylene carbonate | 0.5 |
| Hardener Component | |
| Aliphatic polyisocyanate (75% in butyl | 100 |
| acetate with NCO content of 16.5%) | |

Example 4: Clear Coat, Glossy

| | Proportion |
|---|---|
| Constituent | [% by weight] |
| Binder Component | |
| Acrylate polyol (OH number 4 to 9 mg KOH/g) | 20 |
| Acrylate polyol (OH number 4 to 8 mg KOH/g) | 10 |
| Acrylate polyol (OH number 3 to 5 mg KOH/g) | 20 |
| Polyester resin containing hydroxyl groups | 20 |
| (OH number 5 to 10 mg KOH/g) | |
| Butyl glycol acetate | 3.5 |
| Light stabilizer(s) | 1.5 |
| Surface additive | 0.5 |
| Catalyst | 0.1 |
| Xylene | 13.4 |
| Solvent naphtha | 11 |
| Hardener Component | |
| Aliphatic polyisocyanate (90% in butyl acetate | 84 |
| and solvent naphtha with NCO content of 19.6%) | |
| Butyl acetate | 10 |
| Xylene | 6 |

Example 5: Clear Coat, Matt

| | Proportion |
|---|---|
| Constituent | [% by weight] |
| Binder Component | |
| Polyester resin containing hydroxyl groups | 31.4 |
| (OH number 50 to 65 mg KOH/g) | |
| Polyester resin containing hydroxyl groups | 5.4 |
| (OH number 120 to 140 mg KOH/g) | |
| Polyester resin containing hydroxyl groups | 6.4 |
| (OH number 280 mg KOH/g) | |
| Matting agent(s) | 11 |
| Rheological additives | 0.4 |
| Surface additive | 2.4 |
| Light stabiliser(s) | 0.8 |
| Catalyst | 0.1 |
| Butyl acetate | 12.5 |
| Ethyl acetate | 2.5 |
| Diacetone alcohol | 25.2 |
| Butyl glycol | 0.6 |
| Xylene | 0.75 |
| Solvent naphtha | 0.5 |
| Methoxypropyl acetate | 0.05 |
| Hardener Component | |
| Aliphatic polyisocyanate (90% in butyl acetate | 84 |
| and solvent naphtha with NCO content of 19.6%) | |
| Butyl acetate | 10 |
| Xylene | 6 |

The production of coating materials from the above-mentioned compositions is carried out according to well-known methods which are familiar to the person skilled in the art.

### Production of the Specimens

### Specimen 1 (Three-Layer Construction)

Substrate: polycarbonate Makrolon® AG 2405
First layer: laser primer Example 1, pneumatic application, oven drying at 80° C., dry film thickness 2 to 6 μm
Second layer: base coat Example 3, pneumatic application, oven drying at 80° C., dry film thickness 40 to 50 μm
Third layer: clear coat Example 5, pneumatic application, oven drying at 80° C., dry film thickness 40 to 50 μm

### Specimen 2 (Three-Layer Construction)

Substrate: polycarbonate Makrolon® AG 2405
First layer: conductive laser primer Example 2, pneumatic application, oven drying at 80° C., dry film thickness 2 to 6 μm
Second layer: base coat Example 3, pneumatic application, oven drying at 80° C., dry film thickness 40 to 50 μm
Third layer: clear coat Example 5, pneumatic application, oven drying at 80° C., dry film thickness 40 to 50 μm

### Specimen 3 (Four-Layer Construction)

Substrate: polycarbonate Makrolon® AG 2405
First layer: laser primer Example 1, pneumatic application, oven drying at 80° C., dry film thickness 2 to 6 μm
Second layer: clear coat Example 4, application method: pneumatic application, oven drying at 80° C., dry film thickness 40 to 50 μm
Third layer: base coat Example 3, pneumatic application, oven drying at 80° C., dry film thickness 40 to 50 μm
Fourth layer: clear coat Example 4, pneumatic application, oven drying at 80° C., dry film thickness 40 to 50 μm

### Test Methods

### Determination of Adhesion (Cross-Cut)

Six parallel cuts are made with a cutter knife on the coating of the specimen to be examined. The cuts into the coating are deep enough to reach the substrate surface without damaging it. A further six parallel cuts are then made, which are perpendicular to the first ones and which form a regular square or grid therewith. The grid spacing is 1 mm. A strip of adhesive tape or masking tape with an adhesive force of 8 to 10 N/25 mm is applied to the square made. The strip is then removed in a time of 0.5 to 1 s at an angle of 60°. The grid or coating is subsequently evaluated visually. The results of the cross-cut test are visually evaluated as set forth below:

| | |
|---|---|
| Gt 0 | smooth cutting edge, no spalling |
| Gt 1 | up to 5% of the sections are chipped off |
| Gt 2 | up to 15% of the sections are chipped off |
| Gt 3 | up to 35% of the sections are chipped off |
| Gt 4 | more than 65% of the sections are chipped off |

The cross-cut characteristic value Gt 0 corresponds to a very good adhesive strength, the characteristic value Gt 4 corresponds to a very poor adhesive strength.

### Determination of Scratch Resistance (Scratch Hardness According to Erichsen):

A weight is applied to a scratch stylus, the tip of which is placed vertically onto the coating to be tested, and the stylus is pulled over the surface to be tested while standing on it. It is subsequently visually assessed whether the tested coating shows a scratch mark. The maximum mass of the weight, with which the scratch stylus can be loaded without damaging the coating during the test, is indicated as measure of the scratch resistance of the coating. The scratch hardness tester type 318 of the company Erichsen is used for this purpose. This tester has a Bosch test needle whose engraving tip exhibits a diameter of 0.75 mm.

### Determination of Hydrolysis Resistance

The coated specimens are stored in a climatic test cabinet for 72 hours at 90° C.+/−2° C. and at ≥93% relative humidity of air. The coated specimens are subsequently conditioned for 30 minutes at a room temperature of +18° C. to +28° C., and then visually assessed. After further 30 minutes of conditioning, a cross-cut test is carried out.

### Determination of Cream Resistance

A gauze bandage is placed onto the coated surface of the specimens. Test cream (test creams A and B of the company Thierry GmbH, Stuttgart) is then applied to the gauze bandage. The cream is pressed through the gauze bandage onto the surface and spread, so that the spaces between the stitches are filled with cream. Excess cream is wiped off. The specimen prepared in this way is stored for 24 hours in a convection oven at 80° C. The gauze bandage is subsequently removed and the remaining cream is wiped off with a cloth. The gauze bandage is then conditioned for 4 hours at room temperature (+18° C. to +28° C.). A cross-cut test is finally carried out.

### Determination of Chemical Resistance

Droplets of different chemical solutions are successively applied to the coated surface of the specimens, using aqueous surfactant solution (commercially available dishwashing liquid), ammoniacal alcoholic cleaning solution (commercially available glass cleaner), ethanol denatured with 1% by weight of methyl ethyl ketone and cleaner's naphtha (boiling range 80-100° C.). After a 10 minute flash-off at room temperature, the specimens are heated for 30 minutes in a convection oven at 60° C. and, subsequently, cooled down to room temperature for a further 30 minutes. After 24 hours of storage at room temperature, the specimens are cleaned with distilled water. The changes in color and quality are subsequently evaluated visually.

### Determination of Conductivity (Layer Resistance)

In a four-point probe measurement, the layer resistance Rs is determined with the aid of a commercially available measuring probe (Ken MR-1 of the company Schütz Messtechnik). It is usually indicated in Ω/sq. Typical values of the layer resistance of touch panel surfaces are in the range of 10-1000 Ω/sq.

### Determination of Transmission

A polycarbonate plastic plate made of Makrolon® 2405 is coated with the coating system to be tested. With the aid of a commercially available spectrophotometer (CM.36dGV of the company Konica Minolta), the transmission of visual light is determined within the range of 400 to 700 nm and then averaged over all wavelength ranges.

### Determination of Visual Covering

The term “visual covering” is hereinafter defined as the covering of the sections of the laser engravings of the coating or coating system by the overlying layers. The coated specimens are examined without backlighting. In the first step, the surface of the coating is examined in daylight. In the second step, the surface is illuminated frontally with a flashlight, and, subsequently, the visibility of the laser-engraved areas is visually assessed as set forth below:

| | |
|---|---|
| 0 | visibility of the engravings in daylight is very good, and |
| | the engravings are haptically perceptible with a finger |
| 1 | visibility of the engravings in daylight is very good, but |
| | the engravings are not haptically perceptible with a finger |
| 2 | engravings are faintly visible in daylight |
| 3 | no visibility of the engravings in daylight, |
| | only upon illumination with a flashlight |
| 4 | no visibility of the engravings in daylight, |
| | nor upon illumination with a flashlight |

### Results

The following table shows the test results achieved. In comparison, the coating systems according to the present invention exhibit a significantly higher light transmission as well as a better covering of the engraved sections.

Table of Test Results

| Specimen | 1 | 2 | 3 |
|---|---|---|---|
| Cross-cut | Gt 0 | Gt 0 | Gt 0 |
| Scratch hardness according to | 20N | 20N | 20N |
| Erichsen | | | |
| Hydrolysis resistance (cross-cut) | Gt ≤ 1 | Gt ≤ 1 | Gt ≤ 1 |
| Cream resistance (cross-cut) | Gt ≤ 1 | Gt ≤ 1 | Gt ≤ 1 |
| Chemical resistance (surface) | no change | no change | no change |
| Transmission | 5% | 5% | 10% |
| Conductivity | <1 | 554 Ω/sq | <1 |
| Covering value | 4 | 4 | 3 |

The present invention is not limited to embodiments described herein; reference should be had to the appended claims.

What is claimed is:

1-15. (canceled)

16. A translucent coating system comprising:
a primer layer which is laser-engravable;
a base coat layer which is translucent; and
a clear coat layer.

17. The translucent coating system as recited in claim 16, further comprising:
an additional clear coat layer which is arranged between the primer layer and the base coat layer.

18. The translucent coating system as recited in claim 16, wherein the primer layer is electrically conductive.

19. The translucent coating system as recited in claim 16, wherein the primer layer comprises at least one primer coating.

20. The translucent coating system as recited in claim 19, wherein the at least one primer coating is prepared from a composition comprising a binder component, the binder component comprising:
10 to 80 wt.-% of at least one polyol,
5 to 30 wt.-% of at least one pigment,
2 to 25 wt.-% of at least one filler, and
a hardener component having at least one isocyanate,
wherein,
the wt.-% s total to 100 wt. %.

21. The translucent coating system as recited in claim 20, wherein the composition from which the at least one primer coating is prepared further comprises 1 to 40 wt.-% of conductive particles.

22. The translucent coating system as recited in claim 16, wherein the base coat layer comprises at least one base coat coating.

23. The translucent coating system as recited in claim 22, wherein the at least one base coat coating is prepared from a composition comprising a binder component, the binder component comprising:
1 to 90 wt.-% of at least one polyol,
0.5 to 5 wt.-% of at least one catalyst,
0.5 to 60 wt.-% of a mixture containing at least one pigment and at least one filler,
0.5 to 50 wt.-% of at least one additive, and
a hardener component having at least one isocyanate,
wherein,
the wt.-% s total to 100 wt. %.

24. The translucent coating system as recited in claim 16, wherein the clear coat layer comprises at least one clear coat coating.

25. The translucent coating system as recited in claim 24, wherein the at least one clear coat coating is prepared from a composition comprising one binder component, the one binder component comprising:
20 to 70 wt.-% of at least one polyol,
5 to 30 wt.-% of at least one additive, and
a hardener component having at least one isocyanate,
wherein,
the wt.-% s total to 100 wt. %.

26. The translucent coating system as recited in claim 25, wherein the composition from which the at least one clear coat coating is prepared further comprises 8 to 14 wt.-% of a matting agent.

27. A method for producing the translucent coating system as recited in claim 16, the method comprising:
applying at least one primer coating to a translucent or transparent substrate so as to produce a primer layer;
removing a part of the primer layer from the translucent or transparent substrate surface via a laser engraving;
applying at least one translucent base coat coating so as to produce a base coat layer; and
applying at least one clear coat coating so as to produce the clear coat layer.

28. The method as recited in claim 27, further comprising:
producing an additional clear coat coating on the primer layer from which the part has been removed via the laser engraving.

29. A method of using the translucent coating system as recited in claim 16, the method comprising:
providing the translucent coating system; and
incorporating the translucent coating system into a backlightable component.

30. The method of using the coating system as recited in claim 29, wherein the backlightable component has an operating function.
